(19) United States
(12) Patent Application Publication
(10) Pub. No.: US 2003/0025325 A1
(43) Pub. Date: Feb. 6, 2003

(54) Attachment element for securing connection components

(76) Inventors: Wolfgang Rehmann, Asperg (DE); Gerhard Hueftle, Aspach (DE); Walter Schieferle, Sonthofen (DE); Thomas Kurzweil, Weitnau (DE); Stefan Fischbach, Ichenhausen (DE); Bernd Kuenzl, Schwieberdingen (DE); Stefan Timmermann, Burgberg (DE)

Correspondence Address: STRIKER, STRIKER & STENBY, 103 East Neck Road, Huntington, NY, 11743, US

(21) Appl. No.: 10/101,685

(22) Filed: Mar. 20, 2002

(30) Foreign Application Priority Data
Apr. 9, 2001 (DE) 101 17 731.3

(51) Int. Cl. F16L 37/00

(52) U.S. Cl. 285/305

(57) ABSTRACT

An attachment element is provided for securing a sensor-type connection component (5) to an attachment point (7). The connection component (5) penetrates a part of a wall (4) of a tube-shaped component (2). The attachment element (12) partially surrounds the connection component (5).

### BACKGROUND OF THE INVENTION

In order to determine temperatures or rates of flow of flowing media in line systems, corresponding measuring elements are provided at attachment points in the supply system. The measuring elements therefore can be screwed into threaded sockets in the line walls and project with their free ends into the line cross section. In this regard, sensors that detect operating parameters can also be provided on walls of components and the apparatus throughout the design.

In U.S. Pat. No. 5,538,439 a two-part measuring element is disclosed. The measuring element includes a socket with an outer threading, which contains an annular groove on a part turned towards the measuring portion of the measuring element. On the measuring portion of the two-piece measuring element, a screw collar ring is provided, whose hooked, inwardly bent ends are engaged in the annular groove of the socket of the two-part measuring element and holds the measuring part on a screw-in socket in a wall.

For assembly of the measuring element disclosed in U.S. Pat. No. 5,538,439 into the wall of the pipe or tube, first the socket portion is screwed into the wall. Next, the measuring portion of the two-part measuring element is inserted into a bore of the socket and the screw collar ring is held with its hook-shaped area in the annular groove.

This solution requires an inner threaded area on the tube line portion, an outer threaded area on the socket portion of the two-part measuring element, as well as a screw collar ring, which secures together both components of the measuring element. In the perspective of manufacturing technology, the screw connection is expensive to manufacture, in view of the fact that the assembly of the measuring element makes a one-handed assembly difficult.

Other possible solutions have been provided, which use lateral clips on attachment positions of the measuring element on the line system or on other various components.

### SUMMARY OF THE INVENTION

The advantages of the attachment element of the present invention are that the inventive attachment element is provided securely on the components to be mounted at a connection point, when the component is a pipe or tube flange or a flat component and, therefore makes possible a one-handed assembly. With the inventive integration of the connection components, such as, for example, a temperature sensor, the assembly can be both simple and cost effective.

The attachment element, then, can be made for this purpose as a sheet trimming part, which connects the connection components with two free legs in a radial direction and includes resilient projections or shoulders projecting in an axial direction with reference to the connection components. By means of the resilient projections of the attachment element, a flush attachment of a temperature sensor, for example, to a socket attachment surface is possible, which can be provided with a chamfer for simplifying the assembly.

Because of the production possibilities of the inventive attachment element as a sheet trimming part or as a injected-plastic part allows a broad spectrum from which to select material thickness and material for a wide variety of design possibilities is possible, when considering specific intended uses.

Instead of a chamfer in the loading area of the attachment components, where the sensors for detecting operating parameters, such as temperature sensors, flow-rate sensor, or flow-medium consistency sensors are secured, the chamfering angle, which facilitates the assembly, can likewise be formed on the attachment element, that is, on its resilient shoulders or projections.

Through the chamfer on the loading area, or the chamfering angle on the resilient shoulders of the attachment element, a tolerance compensation in an axial direction takes place, so that a secure attachment of the connection components to the stop surfaces of a socket of the attachment point is made possible. An unlocking of the attachment element, which has two arresting sections running in a vertical direction, with which it is fixed on the operating parameter-sensing attachment components, is not possible without the use of a tool.

In a cost-effective manner for manufacturing technology, the thread-cutting process can be excluded; the fixing of the attachment components to the attachment points can take place without tools, while breaking the interlocking connection between the operating parameter-sensing attachment components, such as a temperature sensor, and the attachment point, is not possible without tools.

### BRIEF DESCRIPTION OF THE DRAWINGS

FIG. 1 shows a front view of measuring sensor secured to an attachment point by means of the attachment element of the present;

FIG. 2 shows a plan view of the measuring sensor on the attachment point, according to FIG. 1; and

FIG. 3 shows a perspective view of the measuring sensor of FIG. 1, projecting into a supply line.

### DETAILED DESCRIPTION OF THE PREFERRED EMBODIMENTS

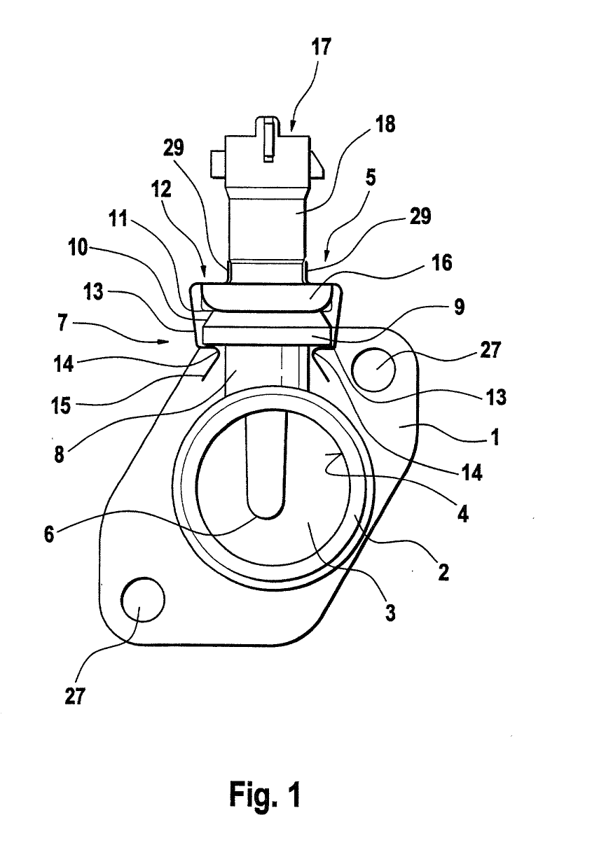

The illustration according to FIG. 1 is a front view of a measuring sensor secured to an attachment point by means of the attachment element of the present invention.

A tube or pipe section 2, which runs perpendicular to the drawing plane of FIG. 1, extends on a flange 1, which is provided with two flange bores 27, according to the representation of FIG. 1. The tube section 2 limits a flow cross section 3 with its inner wall 4, through which a flowable medium, such as a gas or liquid, flows. By means of an attachment or connection component 5, such as a thermometer or a sensor, which measures the flow rate or other parameters of the fluid flowing through the flow cross section 3, various operational parameters can be determined. In this connection, a sensor tip 6 of the attachment component 5 penetrates through the wall of the tube section 2 and projects into the free flow cross section 3 of the tube section 2. On the outer surface of the tube section 2, a connection point 7 is formed.

The connection or attachment point 7 includes a tower-like socket or base 8, on which an annular coupling surface 9 is formed. The coupling surface 9 can be provided with a chamfer 10, on whose abutting face, a contact surface 11 for an attachment element 12 is formed. Opposing spring projections 12 are formed on the sides facing the collar or band 9 on the attachment element 12, which, as shown in FIG. 1, can be formed as a metal sheeting portion integrated into the attachment component 5, The spring projections 13 include an offset portion or recess 14, which engages the collar 9 of the attachment point 10 on the side facing away from the contact surface 11. Through the counter engagement of the spring projections 13 on the attachment element 12, an axial tolerance on the attachment element 12, or the contact surface 11, is compensated for, so that instead, a flush contact of the attachment component 5 on the contact surface 11 of the collar 9 is achieved.

The chamfer 10 formed on the collar 9 is preferably structured as a 60° chamfer, however, other chamfer angles are also contemplated, such as a chamfer angle of 45°. The free ends 15 of the spring projections 13 of the attachment element 12 are facing toward the outer surfaces of the tube section 2. In the front view of FIG. 1, a stop surface 16 is contemplated, which is constructed to angle away from the attachment element 12 by 90°.

Arresting or stop sections are designated with reference numeral 29, with which the attachment element 12 is secured to the connection component 5. The stop sections 29 of the attachment element 12 can be enclosed, for example, by tube-shaped sections 18 of the connection component, and so then is connected with the attachment component 5. In the upper area 17 of the connection component 5, detents can be provided, with which a connection plug of an electrical connection can be latched and connected with the component 5.

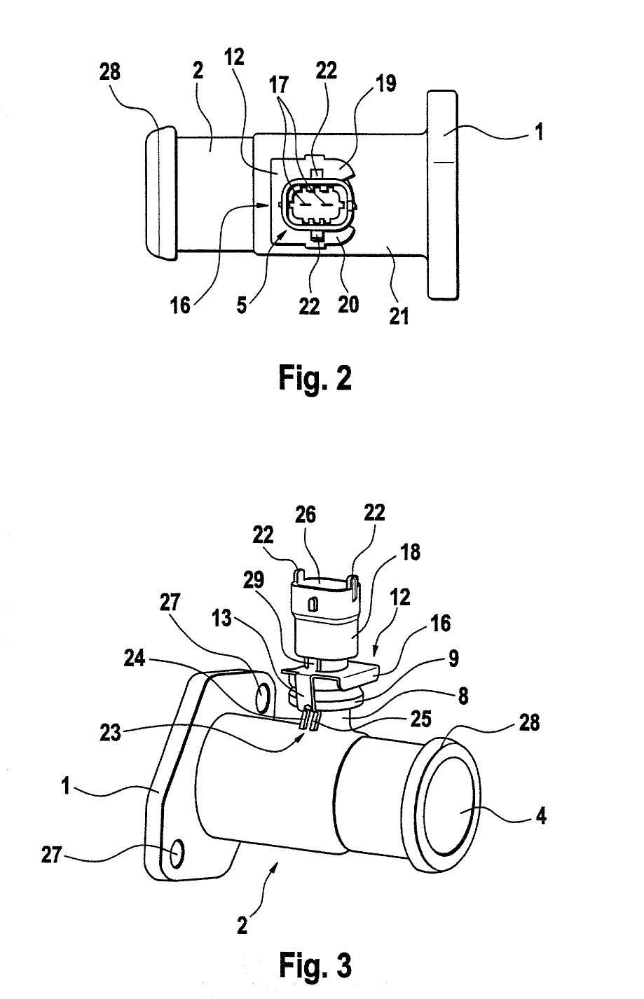

FIG. 2 is a plan view of the attachment component on the connection side of the tube section.

According to the representation of FIG. 2, the attachment element 12, which can be formed as a metal sheeting portion, a retaining clip, or as an injected-plastic component, surrounds the connection component 5 partially at its periphery. Thus, on the attachment element 12 oppositely lying legs 19, 20 (defining a horse-shoe shape) are formed, whose free ends define an opening 21 on the periphery of the connection component 5. In the plan view of FIG. 2, the integrated arresting or stop sections 29 of the attachment element 12, formed in the tube-like section 18 of the connection component 5, are not visible. Detents 22 can be formed in the upper area 17 of the connection component 5 above the attachment element 12, as shown in FIG. 2, on which a plug of a connection cable for the connection component 5, such as a sensor for measuring temperature, flow rate or other parameters, is connectable to the processing unit.

The stop surface 16 extends onto the tube section 2 perpendicular to the plane of the drawing shown in FIG. 2. The tube section 2, which is formed on the flange 1, surrounds a connecting chamfer 28 for a flexibly formed line or conduit section or another line element, which can be provided on the flange 1 at the opposite end from the tube section 2.

The ends of the first leg 19, or the second leg 20, facing away from the stop surface 16 secure the attachment element 12, which is received on the connection component 5, against movement in the radial direction, with reference to the attachment component 5. In this connection, an unlocking of the connection between the connection component and the attachment point 7 of the tube section 2, covered by the attachment element 12, is not possible without a tool.

FIG. 3 shows a perspective view of a temperature sensor projecting in a free flow cross section of a tube section.

From the illustration of FIG. 3, the arresting or stop sections 29 in continuation of the spring projections 13, are covered by the tube-shaped section 18 of the connection component 5, and therefore, are connected to them. In the upper region of the tube section 18, a pair of detents or notches 22 are formed, which are formed on a receiving opening 26. A plug element, with which data and signals from the temperature sensor can be supplied to a further processing unit, can be latched and connected onto the detents 22. The detents, indicated in FIGS. 2 and 3 with reference numeral 22, can be formed in varying shapes that extend from the receiving opening 25 in the radial direction, even though designated with the same reference numeral. The detents can also lie opposite one another or be formed at a 90° angle to one another on the periphery of the receiving opening 26. Also, the detents can extend upwardly in the vertical direction. The interior of the steps of the receiving openings 26 can likewise be formed as notched openings, which serves as snap connections for a plug element.

The spring projections 13, which extend in the direction of the outer surface of the tube section 2 of the flange 1, can include a slot 23 at its lower free ends 15, which subdivides the free ends 15 of the spring projections 13 into a spring guide 24 and a spring guide 25. Upon mounting the connection component 5 on the collar 9 with the chamfer 10 and of the tower-shaped socket 8, the free ends 15 of the spring projections 13 are widened, so that a introduction of the sensor tip 6 of the connection component 5 through the wall 4 of the tube section 2 into the free flow cross section 3 can take place. In this regard, it is possible to form the widening chamfers also on the spring projections 13 of the attachment element 12. The stop surface 16 of the attachment element 12, as well as the legs 19, 20, surrounded partially at the periphery of the connection component 5, prevent the relative movement of the connection component in reference to the attachment point 7 on the tower-like socket 8 of the tube section 2.

From a manufacturing technology perspective, the present invention provides distinct advantages by providing attachment possibilities of a connection component 5 by means of an integrated attachment element 12, thus enabling a one-handed assembly of a temperature sensor on a tower-like socket 8 on an attachment point 7 on a tube section 2. The spring projections 13, which extend in the direction onto the outer surface of the tube section 2, hold the connection component 5 in an axial direction under a spring-bias force, so that its flush connection to the connecting surface 11 (as shown in FIG. 1) of the collar 9 of the attachment point 7 is permanently ensured. By the selection of design parameters, such as material section or the wall thickness of the attachment element 12, various attachment forces can be supported.

It will be understood that each of the elements described above, or two or more together, may also find a useful application in other types of constructions differing from the types described above.

While the invention has been illustrated and described herein as an attachment element for securing connection components, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. An attachment element for securing a connection component (5) that senses operating parameters to an attachment point (7), whereby the connection component (5) penetrates a part of a wall (4) of a tube-shaped component (2), wherein the attachment element (12) partially surrounds the connection component (5).

2. The attachment element according to claim 1, wherein the attachment element (12) surrounds the connection component (5) with horseshoe shaped legs (19, 20).

3. The attachment element according to claim 2, wherein the legs (19, 20) have free ends, wherein said free ends define an opening (21) at a periphery of the connection component (5).

4. The attachment element according to claim 1, further comprising spring projections, wherein said spring projections extend in an axial direction to said attachment point (7).

5. The attachment element according to claim 4, wherein said tube-shaped component has a collar (9), said collar (9) having a contact surface (11), wherein the spring projections have chamfered portions, whereby the chamfered portions operate to widen the spring projections (13) upon assembly of said attachment element to said connection component.

6. The attachment element according to claim 4, wherein said attachment point (7) of said attachment element (12) has a peripheral chamfer (10), whereby said chamfer (10) separates from one another the spring projections (13) upon assembly of the connection component (5).

7. The attachment element according to claim 6, wherein the chamber (10) has an angle of 60°.

8. The attachment element according to claim 1, wherein said attachment element is formed as a metal sheeting part.

9. The attachment element according to claim 1, wherein said attachment element is formed as an injected-plastic part.

10. The attachment element according to claim 1, wherein said attachment element is formed as a retaining clip.

11. The attachment element according to claim 1, wherein said connection component is a temperature sensor, wherein said temperature sensor is attached to said tube-shaped component (2).
